(19) United States
(12) Patent Application Publication
(10) Pub. No.: US 2024/0180360 A1
(43) Pub. Date: Jun. 6, 2024

(54) DISCHARGING MECHANISM FOR AUTOMATIC COOKING DEVICE, AUTOMATIC COOKING DEVICE AND AUTOMATIC COOKING METHOD

(71) Applicant: Hestia Technology Limited, Kwun Tong (HK)

(72) Inventors: Chim Lee CHEUNG, Kwun Tong (HK); Ka Tak LEE, Kwun Tong (HK); Yao Lin PENG, Kwun Tong (HK); Kwok Wing YUEN, Kwun Tong (HK); Lik Choi LEE, Kwun Tong (HK); Siu Fai MAK, Kwun Tong (HK); Hing Choi FU, Kwun Tong (HK); Chun Kit CHAN, Kwun Tong (HK)

(21) Appl. No.: 18/527,014

(22) Filed: Dec. 1, 2023

(30) Foreign Application Priority Data
Dec. 2, 2022 (CN) 202211543225.2

(51) Int. Cl. A47J 36/00; A47J 44/00

(52) U.S. Cl. CPC A47J 36/00; A47J 44/00

(57) ABSTRACT

A discharging mechanism for automatic cooking device, an automatic cooking device and an automatic cooking method. In the automatic cooking device, a conveyer belt, a discharging mechanism, a cooking component and other operation units are arranged compactly to significantly reduce floor space. A feed toggle device in the discharging mechanism picks ingredient boxes on the conveyer belt and pushes the ingredient boxes to storage platforms. A feed grip device in the discharging mechanism picks an ingredient box on the storage platform and rotates to move the ingredient box over a cooking pot, thereby pouring the ingredient into the cooking pot. Further, the feed grip device rotates the empty ingredient box over a garbage bag hanging ring and enables the ingredient box to fall into a garbage bag. All units in this automatic cooking device are compactly arranged to save space and cover small area, particularly suitable for small kitchens.

### TECHNICAL FIELD

The present invention relates to the field of cooking devices and cooking methods for small kitchens, particularly to a discharging mechanism for automatic cooking device, an automatic cooking device and an automatic cooking method.

### BACKGROUND ART

Among the existing cooking devices, the patent with a publication number of CN109573554A discloses an ingredient box discharging and moving mechanism for automatic cooking device and an automatic cooking device. In order to facilitate the picking of ingredients, the ingredient boxes that store ingredients are generally laid flatly in a single layer next to the cooking table, resulting in a large floor space of the discharging mechanism, not suitable for small kitchens and restaurants in the places with strained space and area. The patent with a publication number of CN108354435A discloses an automatic cooking device and a cooking method using the automatic cooking device to solve the problem of a large floor space of the flatly laid ingredient boxes, but the ingredient boxes in the discharging mechanism are stored in a cabinet and placed vertically at different heights, the cabinet is an enclosed structure as a protection and the frame is clumsy and space consuming, so it is also not suitable for small kitchens. Moreover, although an enclosed cabinet can perfectly protect the safe placement of ingredients, in the field of automatic cooking it will bring difficulty in the R&D of a series of operations, including opening the cabinet door, arranging ingredient boxes and closing the cabinet door, so how to reduce the floor space of the discharging mechanism while placing ingredient boxes stably is an issue that needs to be solved in the art.

Current cooking devices mostly adopt manual addition of ingredients. The patent with a publication number of CN208692934 discloses an ingredient selection and charging mechanism for automatic cooker. It is a common automatic charging method at present, and completes charging by magnetic suction of ingredient boxes, but we know it is hot on the side of the cooking table, which will affect magnetic force, resulting in unstable performance. In addition, this charging mechanism uses a support arm to toss ingredients into the pot, prone to ingredient splash, affecting the hygienic condition of the working environment. Therefore, it is necessary to put forth a physical gripping device to ensure the stability of the charging process.

### SUMMARY OF THE INVENTION

The present invention provides a discharging mechanism for automatic cooking device, an automatic cooking device and an automatic cooking method, wherein the discharging mechanism is vertically distributed in an open manner, covers a small floor space, makes for charging and can be placed stably.

The present invention adopts the following technical means:

A discharging mechanism for automatic cooking device, arranged on a cooking table, wherein the discharging mechanism:
comprises a lifting device arranged on the side of the cooking table in a liftable manner and comprising a plurality of storage platforms of different heights overlapping in the vertical direction; and
a feed grip device located on the side of the storage platforms and rotatably arranged on the top of the cooking table.

Preferably, the lifting device comprises an upright bracket, which is arranged on the side of the cooking table in a liftable manner and on which the storage platforms are arranged horizontally.

Preferably, each of the storage platforms comprises a U-shaped outer edge fixedly arranged on the upright bracket, a first base is arranged on the outer edge and in the middle of a U-shaped opening of the outer edge, and a second base matched with the structure of the opening of the outer edge is arranged at the opening of the U-shaped outer edge.

Preferably, the outer edge is higher than the first base and the second base, and the first base, the second base and the outer edge form a storage space open on the top to accommodate an ingredient box.

Preferably, one or more base sensors are arranged on the top surface of the first base.

Preferably, the upright bracket comprises a vertical plate and a connecting plate, the storage platforms are arranged on the vertical plate, the connecting plate is in an L shape, and the bottom end of the L-shaped connecting plate is provided with a moving part, which is arranged on the side of the cooking table in a liftable manner.

Preferably, a vertical chute is arranged on the side of the cooking table where the lifting device is arranged, a sliding component is arranged inside the cooking table and along the chute and comprises a lead screw arranged at the chute, a slider slidably arranged on the lead screw, and an electric actuator arranged on the side of the lead screw and electrically connected to the slider, and the moving part and the slider pass through the chute and are fixedly connected.

Preferably, the feed grip device comprises a first shaft driver arranged inside the cooking table, the top of the first shaft driver is rotatably connected to a first grip shaft, the top of the first grip shaft is connected to a rotary chamber, the rotary chamber is located on the top of the cooking table, and an open-type horizontal bar is arranged in the horizontal direction of the rotary chamber.

Preferably, the open-type horizontal bar comprises a handle connected to the rotary chamber, the end of the handle away from the rotary chamber is provided with an arc claw, and the inner side of the arc claw is provided with an arc groove.

Preferably, a second push rod shaft is arranged in the rotary chamber, and comprises a telescopic driver arranged inside the rotary chamber, the telescopic driver is connected to a telescopic rod in a telescopic and horizontal manner on the side adjacent to the open-type horizontal bar, the telescopic rod is extended outside the rotary chamber, the end of the telescopic rod away from the telescopic driver is provided with an arc pawl, the periphery of the telescopic rod is provided with a movable rod fixedly connected to the telescopic driver, and the handle of the open-type horizontal bar is arranged on the movable rod located outside the rotary chamber.

Preferably, a second shaft driver is arranged inside the rotary chamber and is rotatably connected to the second push rod shaft.

An automatic cooking device, comprising the foregoing discharging mechanism.

Preferably, the automatic cooking device further comprises a cooking component arranged on the cooking table on the side of the feed grip device at a height matched with the height of the feed grip device.

Preferably, the cooking component comprises a cooking pot and a roll-over stand, the cooking pot is arranged on the roll-over stand in a rotatable manner, the roll-over stand is rotatably arranged on the cooking table, the rotary shaft of the roll-over stand is a horizontal shaft, and the rotary shaft for rotation of the cooking pot is a center shaft perpendicular to the bottom surface of the cooking pot.

Preferably, a turntable device that can rotate horizontally is arranged on the cooking table at the bottom of the cooking pot, and comprises a turntable driver arranged inside the cooking table, the top of the turntable driver is provided with a turntable shaft in a rotatable manner, the top of the turntable shaft is arranged outside the cooking table, a turntable bracket is horizontally connected to the turntable shaft outside the cooking table, the end of the turntable bracket away from the turntable shaft is provided with a clamp, a serving plate is clamped on the clamp, and when the turntable bracket rotates to the bottom of the cooking pot, the serving plate is under the cooking pot.

Preferably, a blowdown device is arranged on the cooking table and located under the cooking pot.

Preferably, an openable loading box is arranged at the bottom of the blowdown device, one or more liquid storage devices are arranged inside the loading box, and a weighing scale is arranged at the bottom of the liquid storage devices.

Preferably, a stirring device and a charging device are arranged on the top of the cooking pot, and the charging device is connected to the liquid storage devices via pipes.

Preferably, a mounting rack is arranged on the cooking table on the side of the cooking pot away from the feed grip device, and a mounting box located on the top of the cooking pot is arranged on the mounting rack, wherein the charging device is arranged in the mounting box and comprises one or more liquid pumps, the bottom surface of the mounting box is provided with nozzles, the liquid storage devices and the liquid pumps all are connected to the nozzles via pipes, and a pump structure is arranged on each pipe.

Preferably, a stirring device is arranged on the side of the nozzles on the bottom surface of the mounting box, and suction tubes connected to the liquid pumps are arranged inside the stirring device.

Preferably, a feed toggle device is arranged on the cooking table behind the feed grip device and comprises a toggle lever driver inside the cooking table, the top of the toggle lever driver is rotatably connected to a toggle lever rotation shaft, the top of the toggle lever rotation shaft is arranged outside the cooking table, and a toggle lever is horizontally arranged on the toggle lever rotation shaft outside the cooking table and can rotate to the side of the storage platform.

Preferably, a conveyer belt connected to a storage mechanism is arranged behind the cooking table and paved till the side of the storage platforms, the height of the conveyer belt on the side of the storage platforms is matched with the height of the toggle lever, ingredient boxes are transported on the conveyer belt, and a first box sensor is arranged on the cooking table on the side of the feed toggle device.

Preferably, a second box sensor is arranged on the cooking table on the side of the feed grip device.

Preferably, a garbage bag hanging ring is arranged on the cooking table on the side of the lifting device, and is on the front side of the lifting device.

Preferably, a monitor that meets the ergonomic requirements is arranged on the front side of the cooking table.

An automatic cooking method based on the foregoing automatic cooking device, comprising:
S1: after receiving a dish cooking instruction, the control system controls the conveyance of ingredient boxes filled with corresponding ingredients to the storage platforms at different heights;
S2: the control system controls the feed grip device to pour different ingredients into the cooking pot in the order required by the dish.

Preferably, further comprising:
S3: the control system controls the charging device to add corresponding cooking oil and seasonings to the cooking pot according to the amount and sequence, and controls the rotation direction and speed, and cooking time of the cooking pot for cooking;
S4: after the cooking is completed, the control system controls the roll-over stand to rotate along the horizontal shaft to pour the finished product in the cooking pot into a serving plate at the bottom of the cooking pot, and controls the turntable device to rotate to hand over the serving plate.

Preferably, S1 specifically comprises:
S1.1: after receiving a dish cooking instruction, the control system outputs a control command to the storage mechanism, and ingredient boxes filled with the required ingredients are sent onto the conveyer belt and conveyed along the conveyer belt to the side of the storage platforms of the lifting device;
S1.2: when the first box sensor on the cooking table detects that an ingredient box on the conveyer belt arrives at the side of the storage platforms, the corresponding storage platform is controlled to ascend or descend to a height matched with the conveyer belt, and then the toggle lever of the feed toggle device is controlled to rotate towards the storage platform and to toggle the ingredient box on the conveyer belt along the U-shaped opening of the outer edge of the storage platform into the storage space of the storage platform and after that, the toggle lever returns to the original position;
S1.3: S1.1-S1.2 are repeated to convey ingredient boxes filled with different ingredients to specific storage platforms at different heights.

Preferably, S2 specifically comprises:
S2.1: the storage platform at the height of the ingredient to be added is controlled to ascend or descend to a height matched with the arc claw of the feed grip device, and the first grip shaft is controlled to rotate, driving the arc claw of the open-type horizontal bar to rotate horizontally to the ingredient box on the storage platform until the inner groove on the inner side of the arc claw is coupled with the upper outer edge of the ingredient box;
S2.2: the movable rod is controlled to stretch towards the ingredient box, driving the arc pawl to move forward and against the outer wall of the ingredient box;
S2.3: after the ingredient box is fixed by the arc claw and the pawl, the lifting device is controlled to move downward, and after the bottom of the ingredient box leaves the storage space, the first grip shaft is controlled to rotate, driving the ingredient box fixed at the open-type horizontal bar and the arc claw to rotate horizontally to the top of the cooking pot;
S2.4: the movable rod is controlled to rotate, driving the ingredient box fixed at the arc claw to rotate till the opening of the ingredient box faces the cooking pot, and the first grip shaft is controlled to rotate clockwise and anticlockwise at a small amplitude, driving the ingredient box to shake slightly, thereby pouring the ingredient in the ingredient box into the cooking pot.

Preferably, S2 further comprises:
S2.5: after the ingredient in the ingredient box is poured into the cooking pot, the second push rod shaft is controlled to rotate in the reverse direction, driving the ingredient box to rotate till the opening of the ingredient box faces away from the cooking pot;
S2.6: the first grip shaft is controlled to rotate, driving the ingredient box at the open-type horizontal bar and the arc claw to rotate horizontally in the direction from the cooking pot to the garbage bag hanging ring, and move the ingredient box to the top of the garbage bag hung on the garbage bag hanging ring;
S2.7: the movable rod is controlled to retract so that the pawl moves away from the ingredient box, and the first grip shaft is controlled to rotate clockwise and anticlockwise at a small amplitude so that the ingredient box is detached from the arc claw and falls into the garbage bag;
S2.8: S2.1-S2.7 are repeated until all the ingredients needed by the dish are added to the cooking pot.

Compared with the prior art, the present invention has the following advantages:
1. The storage platforms of the discharging mechanism in the present invention are distributed vertically and arranged on the side of the cooking table in a liftable manner, cover a small floor space and are particularly suitable for small kitchens. Further, the storage platforms are open platforms, making for automatic placement of ingredient boxes and can effectively limit the positions of the ingredient boxes, ensuring stable placement of the ingredient boxes.
2. The feed grip device in the present invention can automatically and physically grip an ingredient box to move stably.

### BRIEF DESCRIPTION OF THE DRAWINGS

FIG. 1 is an overall structural schematic view of an automatic cooking device provided by the present invention.

FIG. 2 is a stereoscopic view of storage platforms.

FIG. 3 is a top view of storage platforms.

FIG. 4 is a structural schematic view of a lifting device in a cooking table.

FIG. 5 is a structural schematic view of the lifting device at an external viewpoint when moved to the highest position.

FIG. 6 is a structural schematic view of the lifting device at an internal viewpoint when moved to the highest position.

FIG. 7 is a structural schematic view of the lifting device at an external viewpoint when moved to the lowest position.

FIG. 8 is a structural schematic view of the lifting device at an internal viewpoint when moved to the lowest position.

FIG. 9 is a schematic view of the moving positions of the storage platforms of the lifting device.

FIG. 10 is a structural schematic view of a pawl of a feed grip device when it does not grip an ingredient box.

FIG. 11 is a schematic view of FIG. 10 at an alternative viewpoint.

FIG. 12 is a structural schematic view of a pawl of a feed grip device when it grips an ingredient box.

FIG. 13 is a schematic view of FIG. 12 at an alternative viewpoint.

FIG. 14 is an internal structural schematic view of a feed grip device.

FIG. 15 is a schematic view of a process in which a feed grip device grips an ingredient box to over a cooking pot, pours the ingredient into the cooking pot and grips and moves the ingredient box to over a garbage bag.

FIG. 16 is a structural schematic view of a loading box at the bottom of a cooking table.

FIG. 17 is a structural schematic view of a turntable device.

FIG. 18 is a structural schematic view of a cooking component.

FIG. 19 is a structural schematic view of the bottom of a mounting box.

FIG. 20 is a structural schematic view of a stirring device.

FIG. 21 is a lateral structural schematic view of an automatic cooking device.

FIG. 22 is a top view of an automatic cooking device.

FIG. 23 is a structural schematic view of a feed toggle device.

FIG. 24 is a schematic view of the positions of a conveyer belt and a feed toggle device (before the ingredient box enters a storage platform).

FIG. 25 is a schematic view of the positions of a conveyer belt and a feed toggle device (when the ingredient box enters a storage platform).

FIG. 26 is a schematic view of the positions of a conveyer belt and a feed toggle device (when the ingredient box enters a storage platform).

FIG. 27 is a top view of FIG. 24.

FIG. 28 is a top view of FIG. 25.

FIG. 29 is a top view of FIG. 26.

FIG. 30 is a schematic view of a process in which the finished product is poured into a serving plate from the cooking pot after completion of cooking.

FIG. 31 is a structural schematic view of an alternative implementation manner of the feed grip device (when it does not grip an ingredient box).

FIG. 32 is a structural schematic view of an alternative implementation manner of the feed grip device (when it grips an ingredient box).

Wherein,
1 lifting device, 11 storage platform, 111 first base, 112 base sensor, 113 second base, 114 outer edge, 115 leading edge, 12 upright bracket, 121 moving part, 122 partition, 123 vertical plate, 124 connecting plate, 13 sliding component, 131 lead screw, 132 electric actuator, 133 slider, 14 chute;
2 feed grip device, 21 first shaft driver, 22 first grip shaft, 23 rotary chamber, 24 second shaft driver, 25 second push rod shaft, 251 pawl, 252 telescopic driver, 253 movable rod, 254 telescopic rod, 26 open-type horizontal bar, 261 handle, 262 arc claw, 263 inner groove, 264 electromagnet;
3 cooking component, 31 cooking pot, 32 roll-over stand, 33 horizontal rotation shaft, 34 rotation shaft;
41 ingredient box, 42 serving plate;
5 cooking table, 51 loading box, 511 liquid storage device, 52 mounting rack, 521 mounting box, 53 blowdown device, 54 first box sensor, 55 second box sensor, 56 garbage bag hanging ring, 57 monitor;
6 stirring device, 61 power unit, 62 container, 63 stirring rod, 64 suction tubes;
7 charging device, 71 liquid pump, 72 nozzle;
8 feed toggle device, 81 toggle lever, 82 feed toggle mounting bracket, 83 toggle lever driver, 84 toggle lever rotation shaft;
9 turntable device, 91 turntable bracket, 911 clamp, 92 turntable shaft, 93 turntable mounting bracket, 94 turntable driver;
10 conveyer belt.

### DETAILED DESCRIPTION

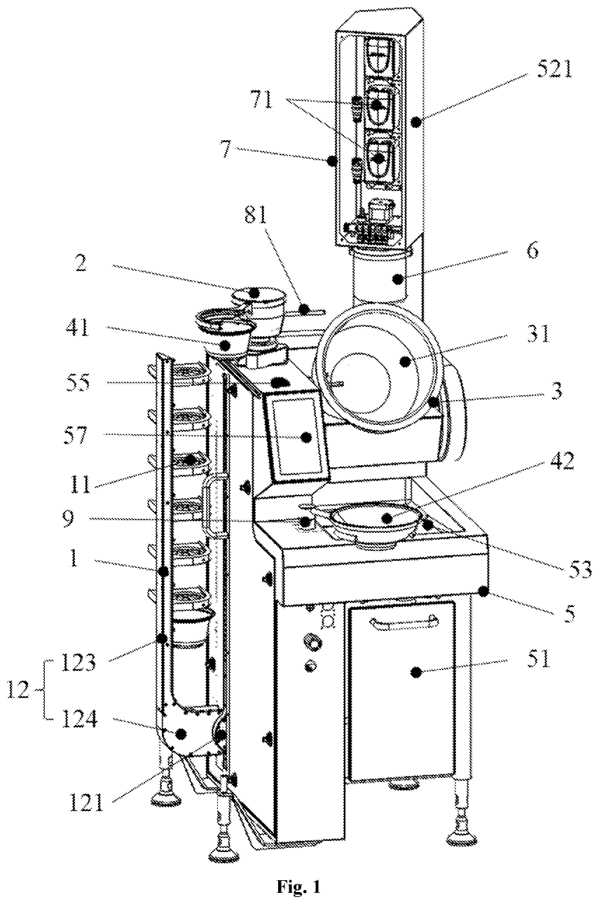

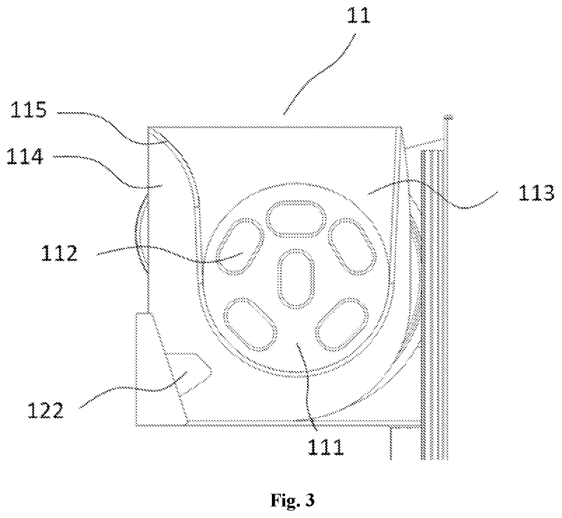

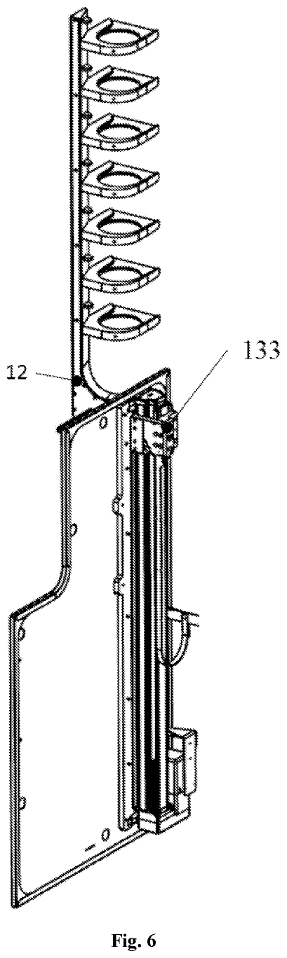

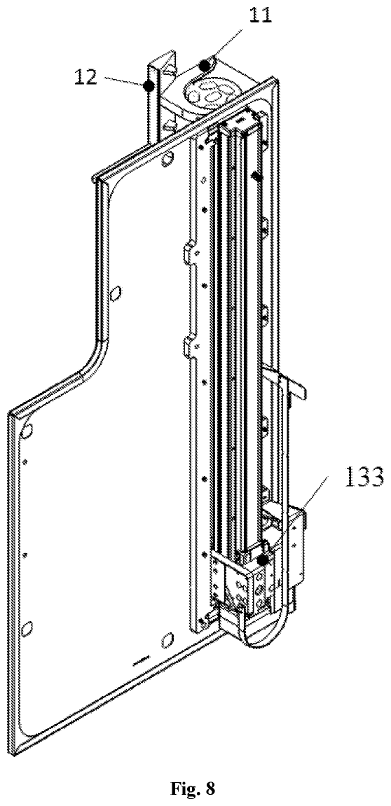

As shown in FIG. 1 to FIG. 9, a discharging mechanism for automatic cooking device is provided. As shown on the left of FIG. 1, the discharging mechanism is arranged on a cooking table 5, wherein the discharging mechanism:
comprises a lifting device 1 arranged on the side of the cooking table 5 in a liftable manner, and a feed grip device 2 located on the side of the storage platforms 11 and rotatably arranged on the top of the cooking table 5. As shown in the top view of FIG. 3, the lifting device 1 comprises a plurality of storage platforms 11 of different heights overlapping in the vertical direction, covers a small floor space and adopts the design of vertical overlapping, which can reduce food contamination.

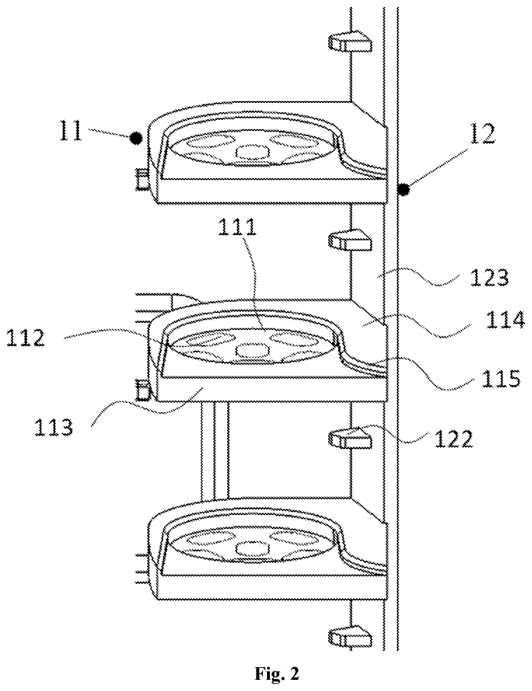

As shown in FIG. 1 and FIG. 2, the lifting device 1 comprises an upright bracket 12, which is arranged on the side of the cooking table 5 in a liftable manner and on which the storage platforms 11 are arranged horizontally. As shown in FIG. 1, the upright bracket 12 comprises a vertical plate 123 and a connecting plate 124, the storage platforms 11 are arranged on the vertical plate 123, the connecting plate 124 is in an L shape, and the bottom end of the L-shaped connecting plate 124 is provided with a moving part 121, which is arranged on the side of the cooking table 5 in a liftable manner. In this way, there is a space between the vertical plate and the side plate of the cooking table 5, and the storage platforms 11 are vertically arranged in the space, which can also play a good role in protecting ingredients; this solution adopts an L-shaped connecting plate 124, so that the ingredients on the storage platforms 11 in this space are visible in front of the cooking table 5, making for monitoring. A partition 122 in the middle of the space of each storage platform 11 is connected on the vertical plate 123. The positions of the partitions 122 and the moving part 121 reduce the chance of fall of the ingredient boxes 41 from the storage platforms when the feed grip 2 grips an ingredient box 41.

As shown in FIG. 2 and FIG. 3, each of the storage platforms 11 comprise a U-shaped outer edge 114 fixedly arranged on the upright bracket 12, a first base 111 is arranged on the outer edge 114 and in the middle of a U-shaped opening of the outer edge 114, is as big as the bottom of the ingredient box 41 in terms of area and is used to place the ingredient box 41, and a second base 113 matched with the structure of the opening of the outer edge 114 is arranged at the opening of the U-shaped outer edge 114 . In an embodiment, the first base 111, the second base 113 and the outer edge 114 are manufactured integrally and fixed on the vertical plate 123 by means of buckle or screw.

Preferably, as shown in FIG. 2, the outer edge 114 is higher than the first base 111 and the second base 113, or still further, the first base 111 is lower than the second base 113, so that the ingredient box 41 moves to the first base 111 in the middle along the U-shaped opening of the outer edge 114, the first base 111, the second base 113 and the outer edge 114 form a storage space open on the top to accommodate an ingredient box 41. Preferably, the outer edge 114 at the U-shaped opening also has a leading edge 115, which makes the opening there even larger to further facilitate the ingredient box 41 to enter the first base 111 from there. The opening design of the outer edge 114 also makes it easier to replace and supplement ingredients or seasonings by hand when cooking some special dishes.

As shown in FIG. 3, one or more base sensors 112 are arranged on the top surface of the first base 111. In the embodiment, a plurality of base sensors 112 are evenly distributed on the top surface of the first base 111, which can detect whether there are ingredient boxes 41 on the storage platforms 1 and detect whether the positions of the ingredient boxes 41 are correct. The base sensors 112 cooperate with the computer programs for real-time monitoring to ensure a correct discharging sequence of ingredients in the process of automatic cooking.

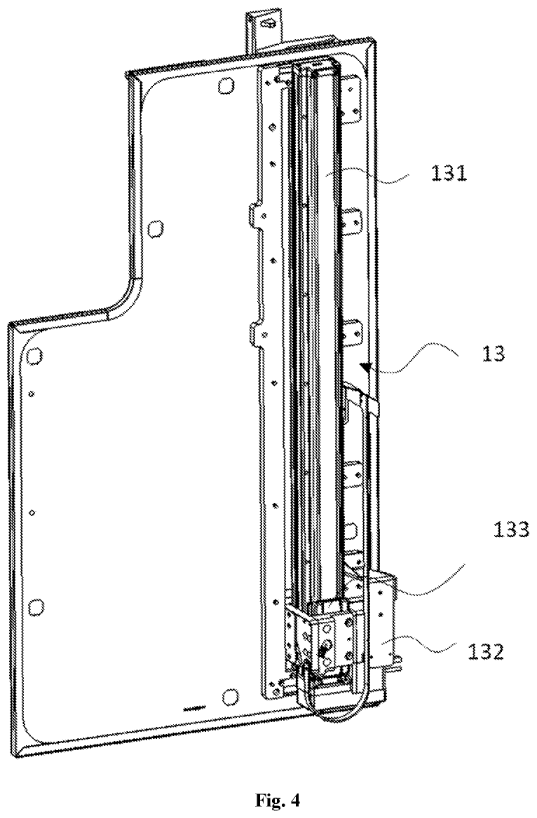

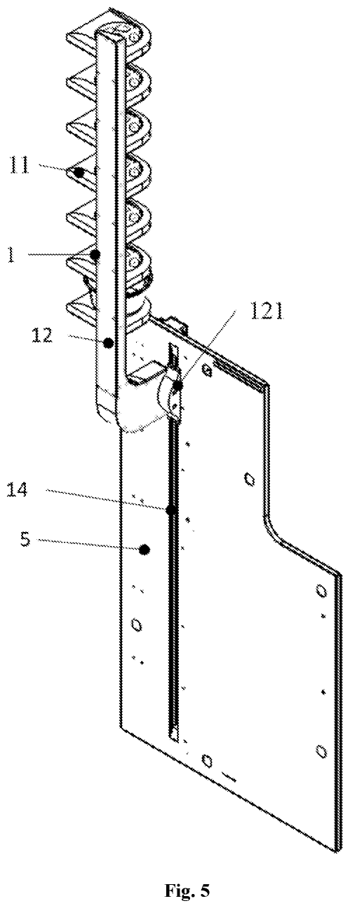

As shown in FIG. 5, a vertical chute 14 is arranged on the side of the cooking table 5 where the lifting device 1 is arranged, a sliding component 13 as shown in FIG. 4 is arranged inside the cooking table 5 and along the chute 4 and comprises a lead screw 131 arranged at the chute 14, a slider 133 slidably arranged on the lead screw 131, and an electric actuator 132 arranged on the side of the lead screw 131 and electrically connected to the slider 133, and the moving part 121 and the slider 133 pass through the chute 4 and are fixedly connected. In this way, the electric actuator 132 provides a driving force, which drives and controls the slider 133 to ascend or descend linearly along the lead screw 131, thereby driving the moving part 121 and the upright bracket 12 to ascend or descend as a whole. The vertical design of the lead screw 131 and the chute 14 can also limit the storage platforms 11 to move vertically only, thereby effectively reducing the chance of splashing of ingredients in the ingredient boxes 41.

In other embodiments, the sliding component can be a pneumatic drive, rack drive or any other drive system commonly used in the art to achieve the effect of precision control of vertical movement.

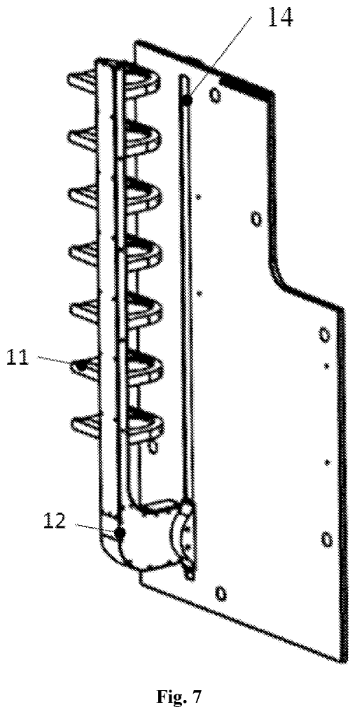

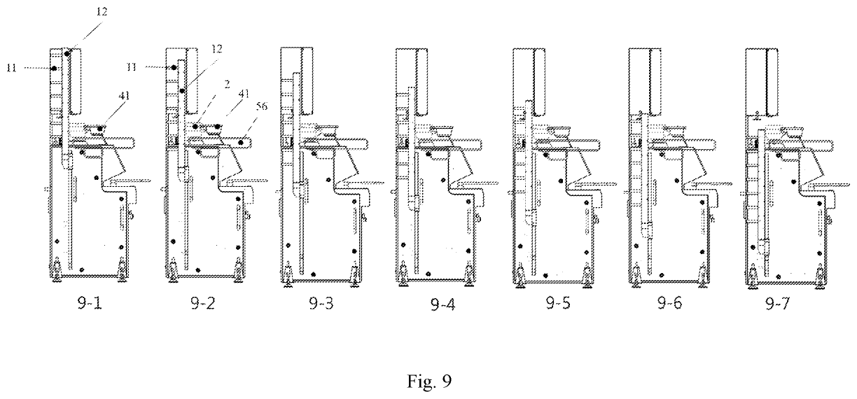

FIG. 5 and FIG. 7 are schematic views of positions when the upright bracket 12 as a whole ascends to the top and descends to the bottom, thereby as shown in FIG. 9, driving the storage platform 11 in each layer to the required height. In FIG. 9, FIG. 9-1 is a schematic view of the lowest storage platform 11 on the upright bracket 12 when the storage platform 11 is at a height where the ingredient box 41 on the storage platform 11 just can be gripped, FIG. 9-2 is a schematic view of the second lowest storage platform 11 on the upright bracket 12 when the storage platform 11 is at a height where the ingredient box 41 on the storage platform 11 just can be gripped, followed by FIGS. 9-3 to 9-7. FIG. 9-7 is a schematic view of the highest storage platform 11 when the storage platform 11 is at a height where the ingredient box 41 on the storage platform 11 just can be gripped. Further, the sliding component 13 is arranged inside the cooking table 5, avoiding exposure while providing a support to driving force, thereby improving durability.

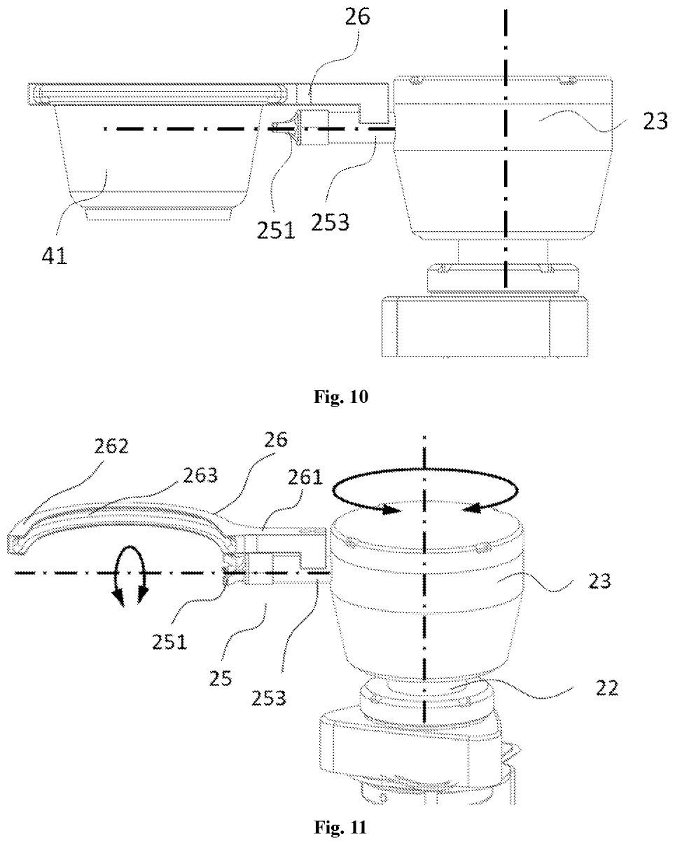

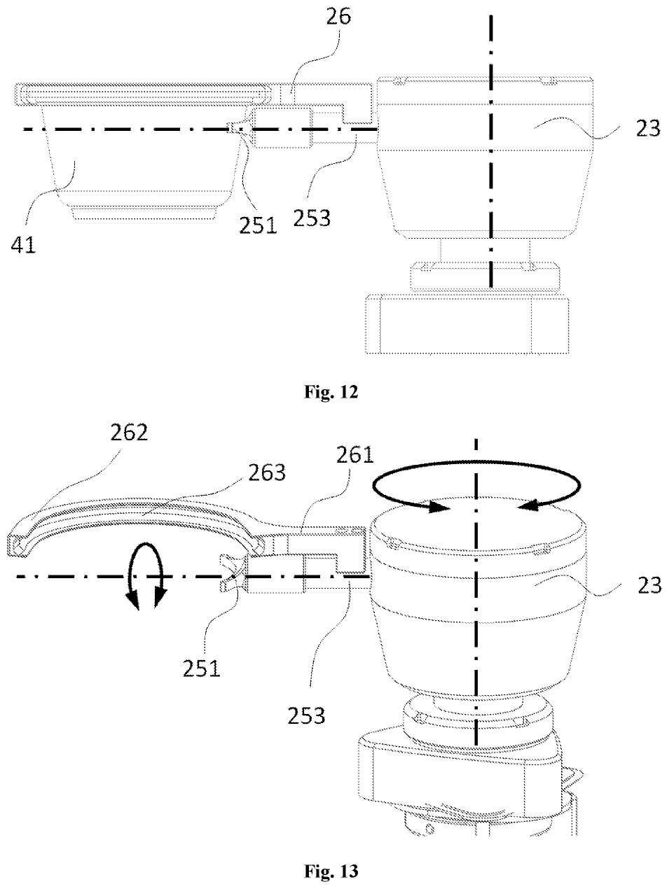

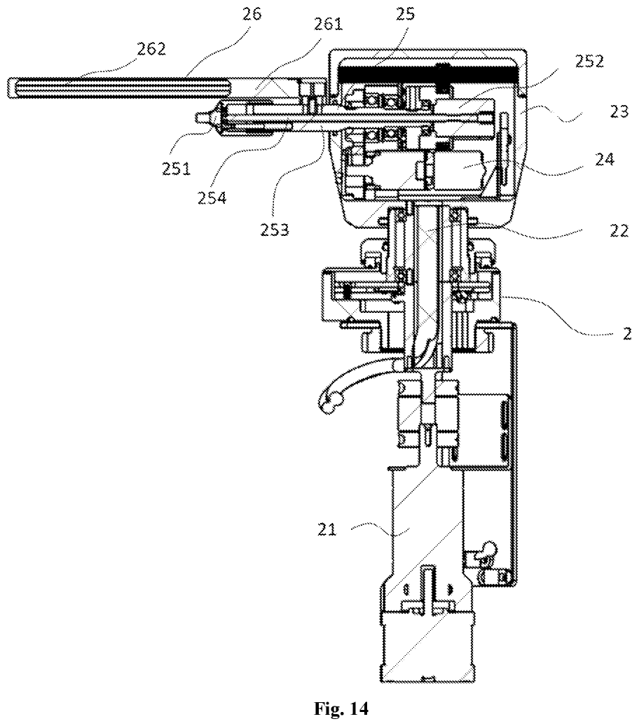

As shown in FIG. 10 to FIG. 14, in FIG. 14, the feed grip device 2 comprises a first shaft driver 21 arranged inside the cooking table 5, the top of the first shaft driver 21 is rotatably connected to a first grip shaft 22, of course a shaft sleeve, a fixing seat and other supporting devices of the first grip shaft 22 are also provided accordingly, the top of the first grip shaft 22 is connected to a rotary chamber 23, the rotary chamber 23 is located on the top of the cooking table 5, and an open-type horizontal bar 26 is arranged in the horizontal direction of the rotary chamber 23.

As shown in FIG. 11, the open-type horizontal bar comprises a handle 261 connected to the rotary chamber 23, the end of the handle 261 away from the rotary chamber 23 is provided with an arc claw 262, and the inner side of the arc claw 262 is provided with an arc groove 263. Preferably, the arc claw 262 is a semicircular arc, and the upper edge of the ingredient box 41 has a protrusion, which can be matched with the arc groove 263 to grip the ingredient box 41 better by means of the arc claw 262.

The ingredient boxes in the present invention are all commonly seen in the market, and have a protrusion on the upper edge. In actual application, the protrusion of the upper edge can be arranged on the opening of the whole ingredient box or a protrusion arranged on part of the box. The key lies in that the protrusion can be matched with the inner groove in the present invention so that the feed grip device can stably grip the ingredient box.

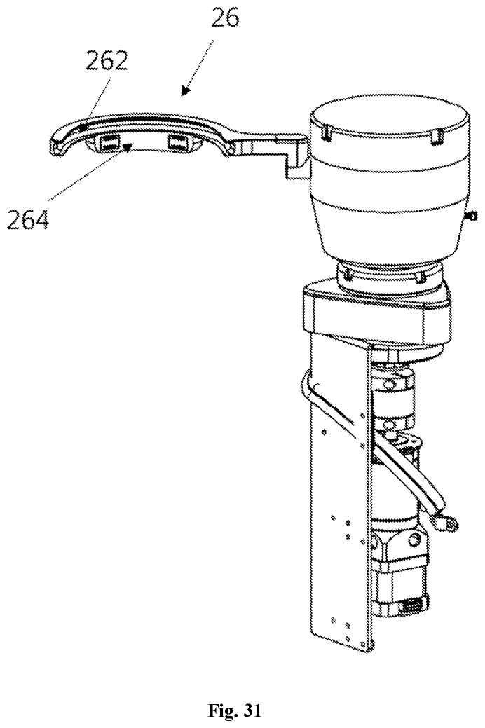

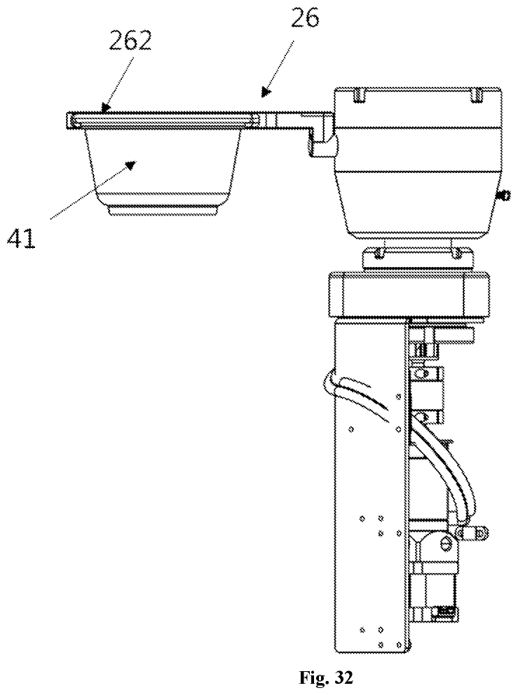

In another embodiment, as shown in FIG. 31 to FIG. 32, an electromagnet 264 is arranged on the open-type horizontal bar 26 and used in cooperation with the magnetic ingredient box. The electromagnet 264 attracts or releases the magnetic ingredient box 41 through magnetic interaction in the way of magnetization when energized and demagnetization when deenergized. Similarly, the magnetic ingredient box 41 may also be attracted or released in the way of demagnetization when energized. The electromagnet 264 in this embodiment can replace the pawl 251, the telescopic driver 252, the movable rod 253, the telescopic rod 254 and the arc claw 262. On the one hand, it reduces the quantities of parts and on the other hand, it can avoid fall of the ingredient box from the arc claw 262 due to deformation of the ingredient box, and improve the stability of conveyance of the ingredient box.

As shown in FIG. 11 and FIG. 14, a second push rod shaft 25 is also arranged in the rotary chamber 23, and comprises a telescopic driver 252 arranged inside the rotary chamber 23, the telescopic driver 252 is connected to a telescopic rod 254 in a telescopic and horizontal manner on the side adjacent to the open-type horizontal bar 26, the telescopic rod 254 is extended outside the rotary chamber 23, the end of the telescopic rod 254 away from the telescopic driver 252 is provided with an arc pawl 251, the periphery of the telescopic rod 254 is provided with a movable rod 253 fixedly connected to the telescopic driver 252, and the handle 261 of the open-type horizontal bar 26 is arranged on the movable rod 253 located outside the rotary chamber 23. In this way, after the upper edge of the ingredient box 41 and the inner groove 263 of the arc claw 262 are against each other, the telescopic driver 252 controls the telescopic rod 254 to stretch, thereby driving the pawl 251 to move towards the ingredient box 41 until the arc pawl 251 is against the lower outer wall of the upper edge of the ingredient box 41 to work with the arc claw 262 to stably grip the ingredient box 41.

As shown in FIG. 14, a second shaft driver 24 is also arranged inside the rotary chamber 23 and is rotatably connected to the second push rod shaft 25 by means of gear or other structures, preferably is rotatably connected to the movable rod 253. In this way, under the driver of the second shaft driver 24, the whole second push rod shaft 25 rotates around the telescopic shaft, thereby driving the gripped ingredient box 41 to turn over upwards or downwards so that the ingredient in the ingredient box 41 falls into the cooking pot 31.

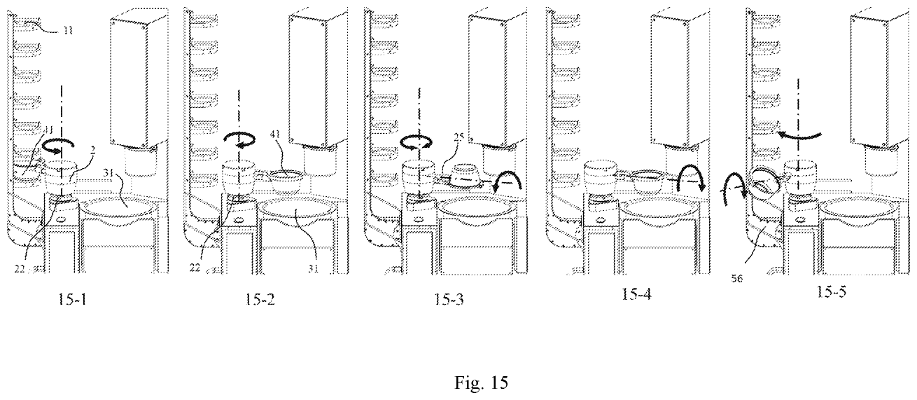

For easier description, in the figures of the embodiments, the vertical direction is y-axis, and the anticlockwise and clockwise directions are based on a viewpoint of top view; the horizontal direction is x-axis, and the anticlockwise and clockwise directions are based on a viewpoint of right view. FIG. 15 is an operation process diagram of the feed grip device 2, FIG. 15-1 shows anticlockwise rotation of the first grip shaft 22 along y-axis. At the moment, the lowest storage platform 11 and the ingredient box 41 on the storage platform 11 ascend to the gripping height, the arc claw 262 moves to the ingredient box 41 and the inner groove 263 is against the upper edge of the ingredient box 41. After the second shaft driver 24 drives the pawl 251 to stretch forward and against the outer wall of the ingredient box 41, the gripping of the ingredient box 41 is completed; further, as shown in FIG. 15-2, the first grip shaft 22 rotates clockwise along y-axis, driving the gripped ingredient box 41 to move to the top of the cooking pot 31 on the cooking table 5; further, as shown in FIG. 15-3, the second shaft driver 24 drives the second push rod shaft 25 to rotate anticlockwise along x-axis, driving the ingredient box 41 to turn over so that the ingredient in the ingredient box 41 falls into the cooking pot 31 at the bottom; further, as shown in FIG. 15-4, after the ingredient in the ingredient box 41 is all poured into the cooking pot 31, the second push rod shaft 25 rotates clockwise again, driving the ingredient box 41 back to the original position; further, as shown in FIG. 15-5, after the first grip shaft 22 continues to rotate clockwise to recover the ingredient box 41, next ingredient box 41 will be gripped, and the foregoing steps are repeated until all the ingredients are added to the cooking pot 31.

Further, as shown in FIG. 1, an automatic cooking device is provided, comprising the foregoing discharging mechanism.

The automatic cooking device further comprises a cooking component 3 arranged on the cooking table 5 on the side of the feed grip device 2 at a height matched with the height of the feed grip device 2 so that the ingredient carried by the feed grip device 2 can be added to the cooking component 3 easily. In the upper layer of the cooking table 5, as shown in FIG. 1, there are storage platforms 11 on the left, a feed grip device 2 in the middle and a cooking component 3 on the right. At the feed grip device 2 in the middle is a workbench, which can not only be provided with functional elements but also realize separation between the cooking zone and the ingredient zone, ensuring the hygienic condition of ingredients and the storage platforms 11 storing the ingredients; and such layout also minimizes floor space.

As shown in FIG. 1 and FIG. 18, the cooking component 3 comprises a cooking pot 31 and a roll-over stand 32, the cooking pot 31 is arranged on the roll-over stand 32 in a rotatable manner, the roll-over stand 32 is rotatably arranged on the cooking table 5, the rotary shaft of the roll-over stand 32 is a horizontal shaft, i.e., the horizontal rotation shaft 33 as shown in FIG. 18, and the rotary shaft for rotation of the cooking pot 31 is a center shaft perpendicular to the bottom surface of the cooking pot 31, i.e., the rotation shaft 34 as shown in FIG. 18. The cooking pot 31 can rotate along rotation shaft 34 at such an angle of inclination, achieving the function of cooking, and the rotation of the roll-over stand 32 along the horizontal rotation shaft 33 can drive the cooking pot 31 to rotate, achieving the functions of filling, cleaning and dumping after cooking.

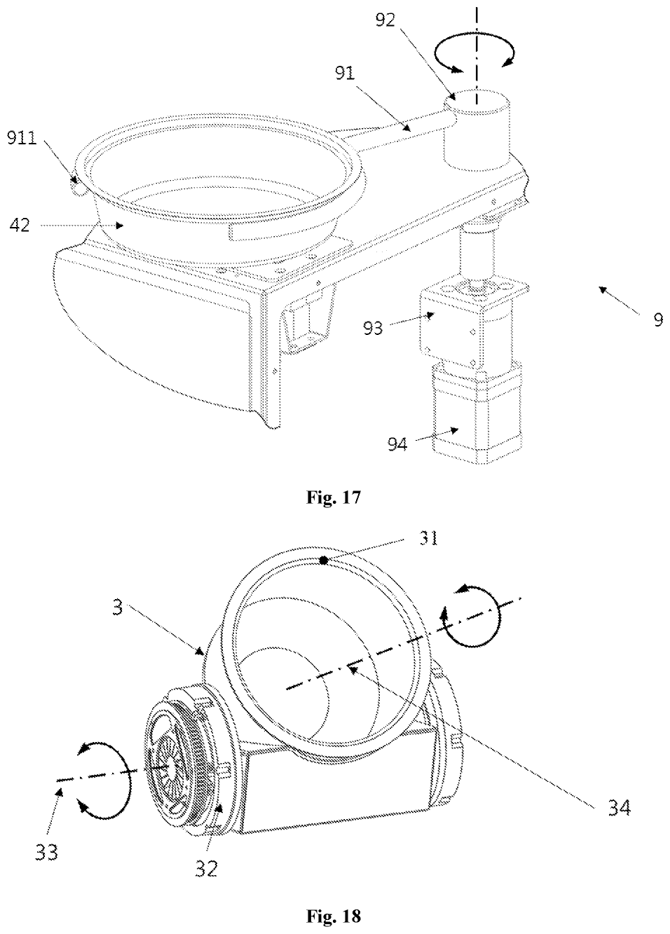

As shown in FIG. 1 and FIG. 17, a turntable device 9 that can rotate horizontally is arranged on the cooking table 5 at the bottom of the cooking pot 31, and comprises a turntable driver 94 arranged inside the cooking table 5, the top of the turntable driver 94 is provided with a turntable shaft 92 in a rotatable manner, the top of the turntable shaft 92 is arranged outside the cooking table 5, a turntable bracket 91 is horizontally connected to the turntable shaft 92 outside the cooking table 5, the end of the turntable bracket 91 away from the turntable shaft 92 is provided with a clamp 911, a serving plate 42 is clamped on the clamp 911, and when the turntable bracket 91 rotates to the bottom of the cooking pot 31, the serving plate 42 is under the cooking pot 31, so that after the cooking pot 31 completes cooking, the finished product is received at the bottom of the cooking pot 31 and moved to the designated position to pass on the serving plate.

As shown in FIG. 1, a blowdown device 53 is arranged on the cooking table 5 and located under the cooking pot 31. When a cooking session is over, the cooking pot 31 is cleaned, and cleaning sewage is poured into the blowdown device 53 and discharged.

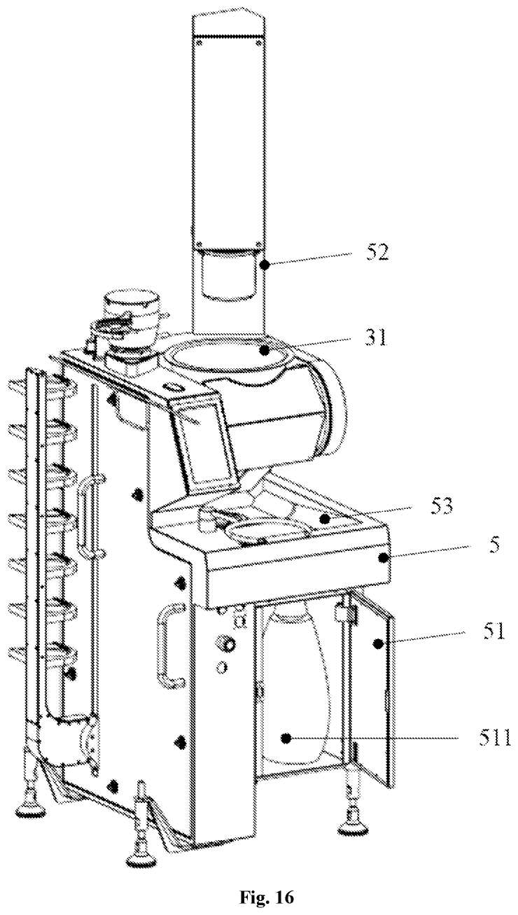

As shown in FIG. 16, an openable loading box 51 is arranged at the bottom of the blowdown device 53, one or more liquid storage devices 511 are arranged inside the loading box 51, and a weighing scale is arranged at the bottom of the liquid storage devices 511. The liquid storage devices 511 can accommodate edible oil, soy sauce, and the like, preferably edible oil, which can be an oil vessel. Compared with the control of the amount used each time by pressure or time, the control by a weighing scale is more accurate.

As shown in FIG. 1, a stirring device 6 and a charging device 7 are arranged on the top of the cooking pot 31, and the charging device 7 is connected to the liquid storage devices via pipes.

A mounting rack 52 is arranged on the cooking table 5 on the side of the cooking pot 31 away from the feed grip device 2, and a mounting box 521 located on the top of the cooking pot 31 is arranged on the mounting rack 52, wherein the charging device 7 is arranged in the mounting box 521 and comprises one or more liquid pumps 71, the bottom surface of the mounting box 521 is provided with one or more nozzles 72, the liquid storage devices 511 and the liquid pumps 71 all are connected to the nozzles 72 via pipes. Preferably, edible oil or other liquids with larger consumption are kept in the larger liquid storage devices 511 at the bottom. In the upper part of the mounting rack 52, for example inside the mounting box 521, smaller liquid storage devices can be arranged to accommodate liquids with smaller consumption, e.g., seasonings, starch solution and detergent, for easier cleaning; for non-liquid seasonings, such addition method can be used, too, as long as the corresponding pump units, storage devices and nozzles are connected.

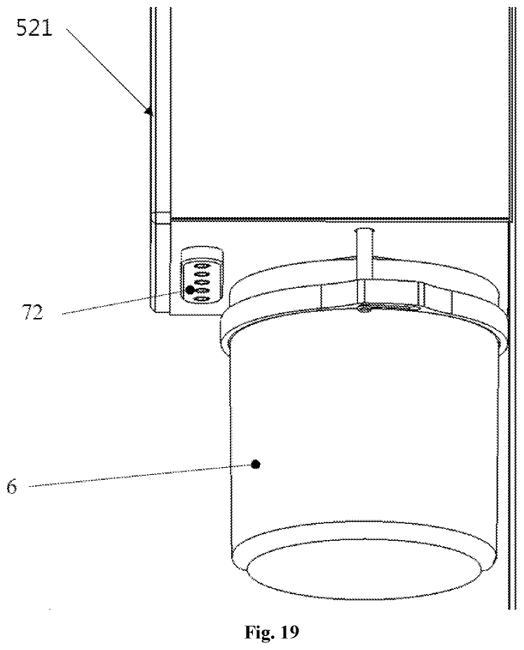

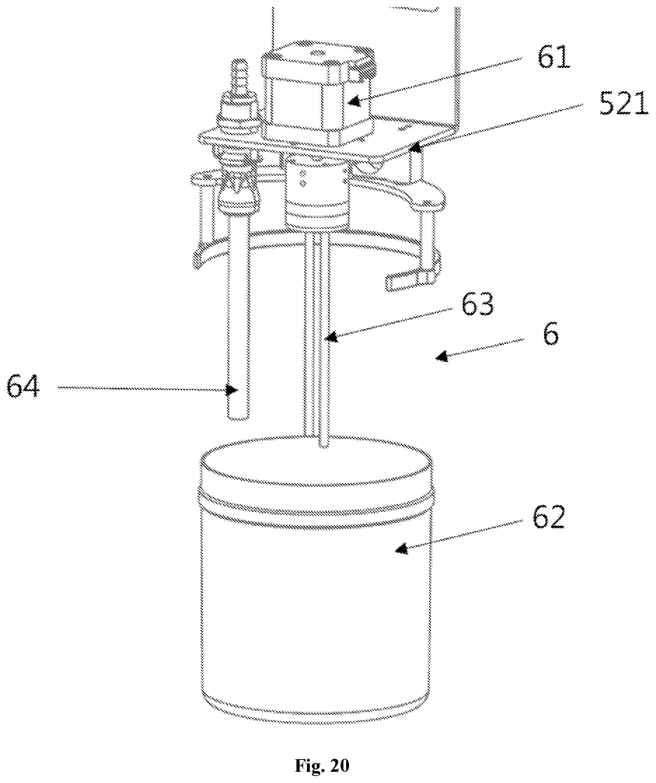

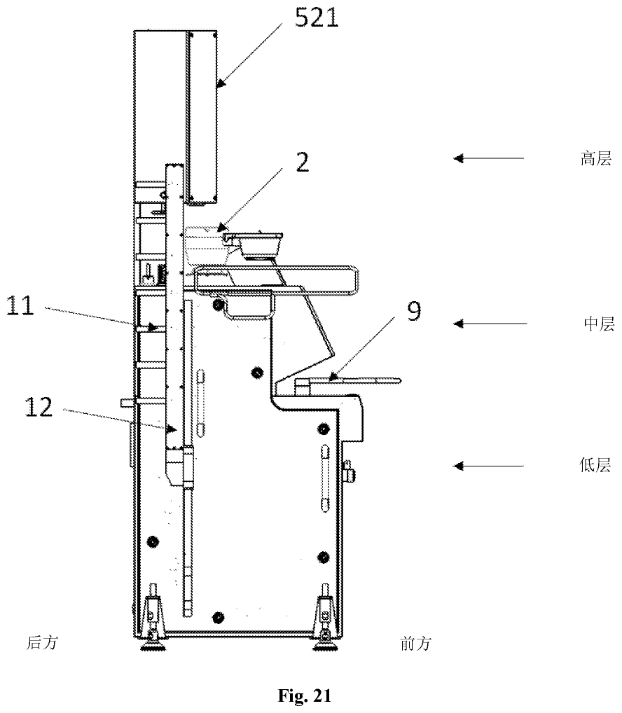

As shown in FIG. 1, FIG. 19 and FIG. 20, a stirring device 6 is arranged on the side of the nozzles 72 on the bottom surface of the mounting box 521, and comprises a power unit 61, a container 62, a stirring rod 63 and suction tubes 64. The container 62 is used to accommodate a liquid containing precipitate, for example a starch solution that is often used during cooking. The power unit 61 is arranged inside the mounting box 521, the stirring rod 63 and the suction tubes 64 extend from the inside of the mounting box 521 into the container 62, and the power unit 61 drives the stirring rod 63 at the bottom to rotate, avoiding the precipitate blocking the pipeline and preventing degradation of such liquid. The power unit 61 can be started on time or manually. The suction tubes 64 are connected to the liquid pumps 71 to pump the stirred liquid in the container 62 to the nozzles 72 as required. As shown in FIG. 1, the right area of the cooking table 5 in this embodiment is optimized for functional zoning. In previous cooking devices, the cooking pot 31, serving plate 42 and blowdown, charging and cleaning devices are all laid flatly to facilitate use, while in this solution, they are distributed vertically, including a charging device 7, a stirring device 6, a cooking pot 31, a serving plate 42, a sewage tank and a loading box 51 vertically distributed on the right side of the cooking table 5, significantly reducing the space occupied.

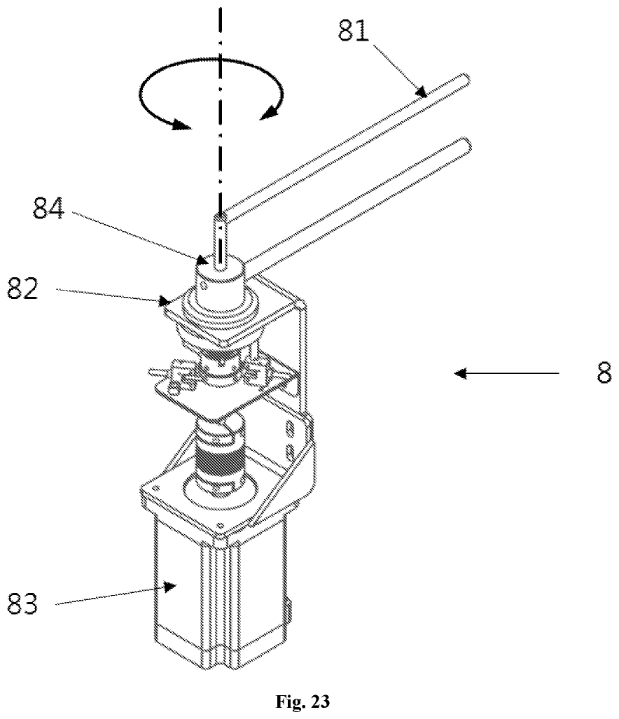

As shown in FIG. 1 and FIG. 23, a feed toggle device 8 is arranged on the cooking table 5 behind the feed grip device 2 and comprises a toggle lever driver 83 inside the cooking table 5, the top of the toggle lever driver 83 is rotatably connected to a toggle lever rotation shaft 84, the top of the toggle lever rotation shaft 84 is arranged outside the cooking table 5, and a toggle lever 81 is horizontally arranged on the toggle lever rotation shaft 84 outside the cooking table 5 and can rotate to the side of the storage platform 11. Specifically, the toggle lever 81 can rotate to the side of the U-shaped opening of the storage platform 11, so that the ingredient box 41 is toggled into the storage space of the storage platform 11.

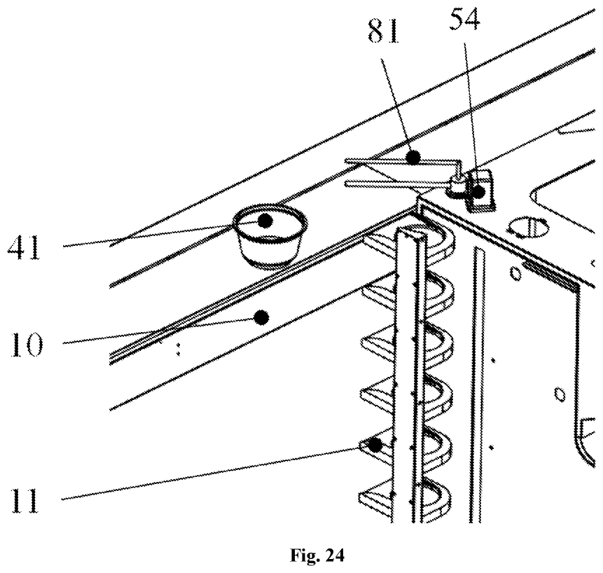

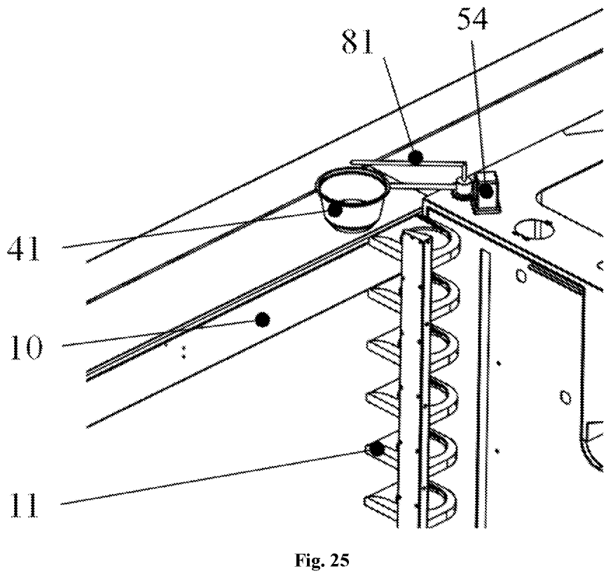

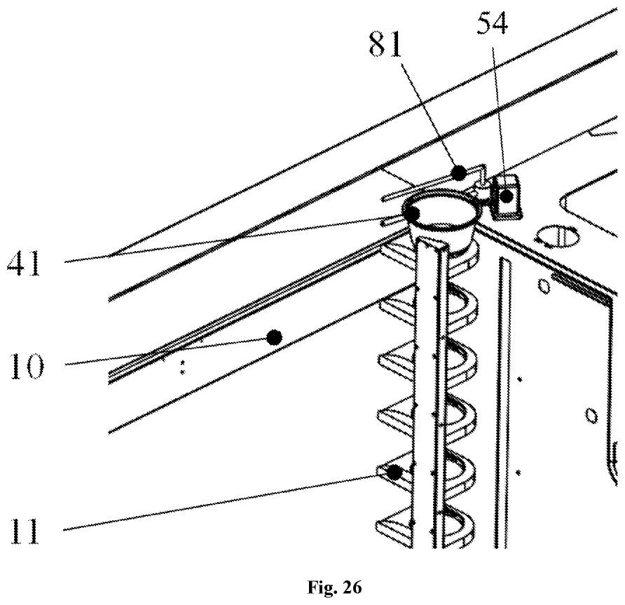

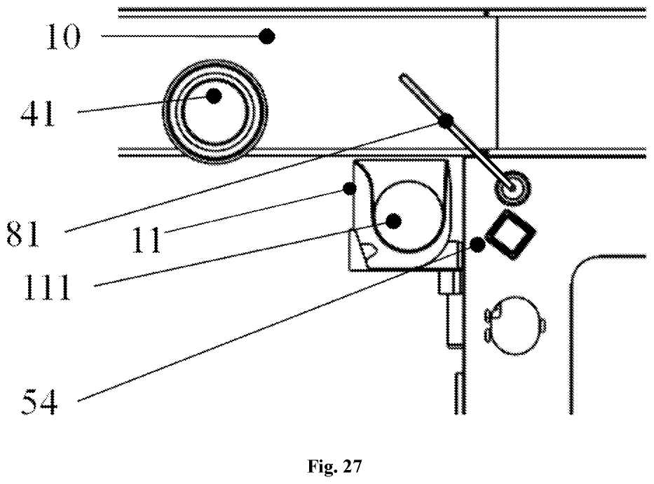

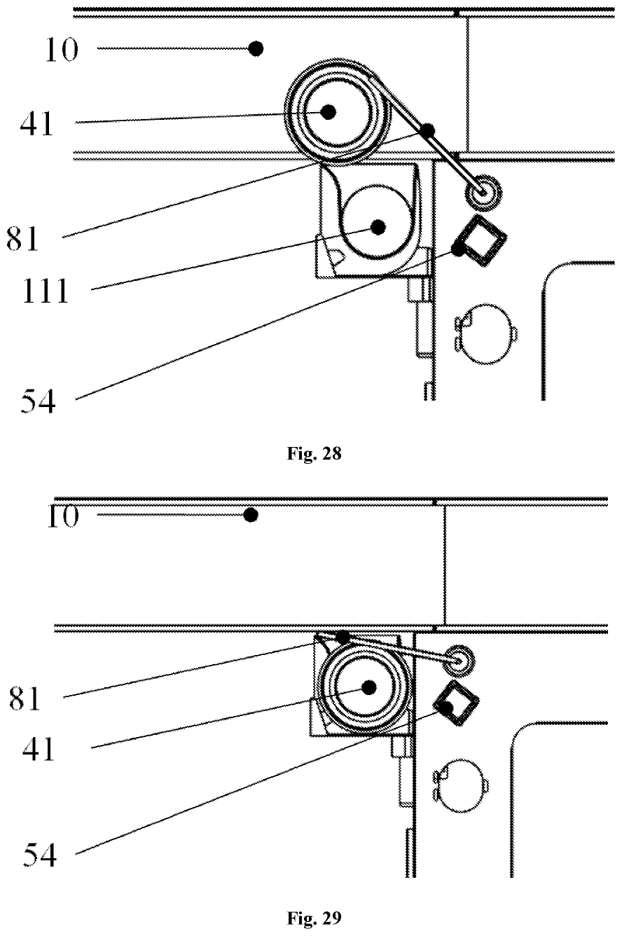

As shown in FIG. 24 to FIG. 29, a conveyer belt 10 connected to a storage mechanism is arranged behind the cooking table 5, the storage mechanism can be a freezer, storage cabinet or a device or work area for storing ingredient boxes 41 and is accessible to the conveyer belt 10 to output the ingredients needed for cooking of dishes, the conveyer belt 10 is paved till the side of the storage platforms 11, the height of the conveyer belt 10 on the side of the storage platforms 11 is matched with the height of the toggle lever 81, ingredient boxes 41 are transported on the conveyer belt 10, and a first box sensor 54 is arranged on the cooking table 5 on the side of the feed toggle device 8. As shown in FIG. 24 to FIG. 25, when the first box sensor 54 detects that an ingredient box 41 is transported to the U-shaped opening of a storage platform 11, the toggle lever driver 83 drives the toggle lever 81 to rotate towards the storage platform 11, as shown in FIG. 26, and to toggle the ingredient box 41 onto the storage platform 11. Of course, in actual operation, it is feasible that some of the ingredient boxes 41 are conveyed to the storage platforms 11 by the conveyer belt 10 and the rest ingredient boxes 41 are put on the storage platforms 11 by hand, depending on the specific ingredients needed by the cooking.

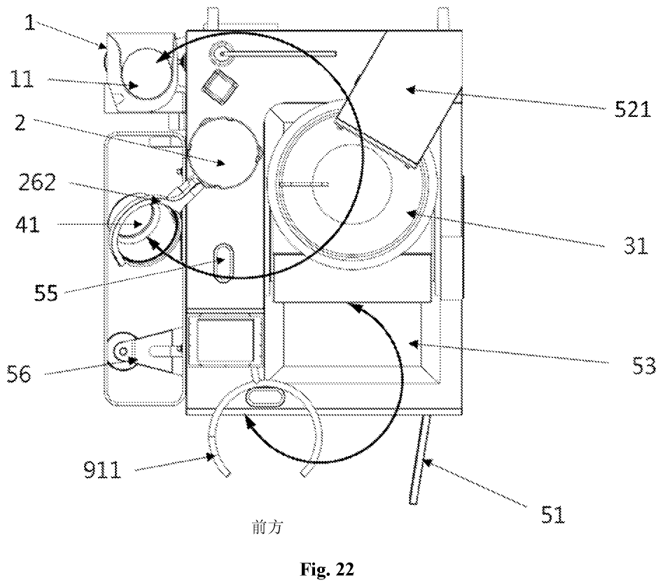

As shown in FIG. 22, a second box sensor 55 is also arranged on the cooking table 5 on the side of the feed grip device 2, which is used to detect whether an ingredient box 41 exists on the feed grip device 2 when the feed grip device 2 grips the ingredient box 41 and rotates towards the cooking pot 31.

As shown in FIG. 22, a garbage bag hanging ring 56 is arranged on the cooking table 5 on the side of the lifting device 1, and is on the front side of the lifting device 1 to facilitate the recovery of the ingredient box 41 on the feed grip device 2 after the ingredient is discharged.

As shown in FIG. 1, a monitor 57 that meets the ergonomic requirements is also arranged on the front side of the cooking table 5, and is used to connect the central control system to monitor and operate the whole automatic cooking device.

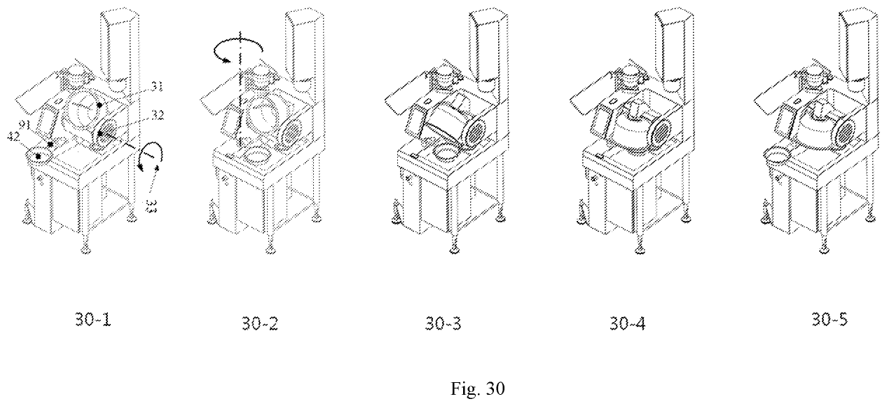

Further, an automatic cooking method based on the foregoing automatic cooking device is provided, comprising:
S1: after receiving a dish cooking instruction, the control system controls the conveyance of ingredient boxes 41 filled with corresponding ingredients to the storage platforms 11 at different heights;
S2: the control system controls the feed grip device 2 to pour different ingredients into the cooking pot 31 in the order required by the dish.
further comprising:
S3: the control system controls the charging device 7 to add corresponding cooking oil and seasonings to the cooking pot 31 according to the amount and sequence, and controls the rotation direction and speed, and cooking time of the cooking pot 31 for cooking; the edible oil and seasonings are pumped to the cooking pot 31 by the liquid storage devices 511 and the liquid pumps 71 according to the recipe;
S4: after the cooking is completed, as shown in FIG. 30, the control system controls the roll-over stand 32 to rotate along the horizontal shaft to pour the finished product in the cooking pot 31 into a serving plate 42 at the bottom of the cooking pot 31, and controls the turntable device 9 to rotate to hand over the serving plate 42. After that, the operator may take away the serving plate 42.
and further comprising:
S5: after the finished product in the cooking pot 31 is poured into a serving plate 42, the cooking pot 31 is back to the original position under the drive of the roll-over stand 32, detergent is sprayed via the charging device 7 for cleaning, and after cleaning, the roll-over stand 32 drives the cooking pot 31 to turn over to discharge the sewage into the sewage tank.
wherein, S1 specifically comprises:
S1.1: after receiving a dish cooking instruction, the control system outputs a control command to the storage mechanism, and ingredient boxes 41 filled with the required ingredients are sent onto the conveyer belt 10 and conveyed along the conveyer belt 10 to the side of the storage platforms 11 of the lifting device 1;
S1.2: when the first box sensor 54 on the cooking table 5 detects that an ingredient box 41 on the conveyer belt 10 arrives at the side of the storage platforms 11, the corresponding storage platform 11 is controlled to ascend or descend to a height matched with the conveyer belt 10, and then the toggle lever 81 of the feed toggle device 8 is controlled to rotate towards the storage platform 11 and to toggle the ingredient box 41 on the conveyer belt 10 along the U-shaped opening of the outer edge 114 of the storage platform 11 into the storage space of the storage platform 11 and after that, the toggle lever 81 returns to the original position; of course, when a special ingredient is needed, ingredient boxes 41 can be placed on specific storage platforms 11 by hand;
S1.3: S1.1-S1.2 are repeated to convey ingredient boxes 41 filled with different ingredients to specific storage platforms 11 at different heights.

Preferably, S2, as shown in FIG. 15, specifically comprises:
S2.1: the storage platform 11 at the height of the ingredient to be added is controlled to ascend or descend to a height matched with the arc claw 262 of the feed grip device 2, and the first grip shaft 22 is controlled to rotate, driving the arc claw 262 of the open-type horizontal bar 26 to rotate horizontally to the ingredient box 41 on the storage platform 11 until the inner groove 263 on the inner side of the arc claw 262 is coupled with the upper outer edge of the ingredient box 41;
S2.2: the movable rod 253 is controlled to stretch towards the ingredient box 41, driving the arc pawl 251 to move forward and against the outer wall of the ingredient box 41;
S2.3: after the ingredient box 41 is fixed by the arc claw 262 and the pawl 251, the lifting device 1 is controlled to move downward, preferably descend vertically at a small amplitude to avoid the ingredient box 41 colliding with the storage platform 11, causing food spill when the ingredient box 41 is separated from the storage platform 11; and after the bottom of the ingredient box 41 leaves the storage space, the first grip shaft 22 is controlled to rotate, driving the ingredient box 41 fixed at the open-type horizontal bar 26 and the arc claw 262 to rotate horizontally to the top of the cooking pot 31;
S2.4: the movable rod 253 is controlled to rotate, driving the ingredient box 41 fixed at the arc claw 262 to rotate till the opening of the ingredient box 41 faces the cooking pot 31, i.e., the second push rod shaft 25 rotates to drive the ingredient box 41 to rotate anticlockwise by 180° to the position as shown in FIG. 15-3; the first grip shaft 22 is controlled to rotate clockwise and anticlockwise at a small amplitude, driving the ingredient box 41 to shake slightly to provide a rocking power and increase the speed of separation of the ingredient from the ingredient box 41, thereby pouring the ingredient in the ingredient box 41 into the cooking pot 31.

Preferably, S2 further comprises:
S2.5: after the ingredient in the ingredient box 41 is poured into the cooking pot 31, the second push rod shaft 25 is controlled to rotate in the reverse direction by 180° to the position as shown in FIG. 15-4, driving the ingredient box 41 to rotate till the opening of the ingredient box 41 faces away from the cooking pot 31;
S2.6: the first grip shaft 22 is controlled to rotate, driving the ingredient box 41 at the open-type horizontal bar 26 and the arc claw 262 to rotate horizontally in the direction from the cooking pot 31 to the garbage bag hanging ring 56, and move the ingredient box 41 to the top of the garbage bag hung on the garbage bag hanging ring 56;
S2.7: the movable rod 253 is controlled to retract so that the pawl 251 moves away from the ingredient box 41, and the first grip shaft 22 is controlled to rotate clockwise and anticlockwise at a small amplitude to accelerate the detachment of the ingredient box 41 so that the ingredient box 41 is detached from the arc claw 262 and falls into the garbage bag;
S2.8: S2.1-S2.7 are repeated until all the ingredients needed by the dish are added to the cooking pot 31.

Of course, in the automatic cooking device, the discharging mechanism, the cooking component 3 and other parts work together coherently, and the control system controls the sequence and time of addition of ingredients into the cooking pot 31 and the cooking time based on the dish to be cooked. The control system controls the addition time and amount of oil, water, starch solution and other liquids in the operation units, controls the rotation direction and speed of the cooking pot 31 and the cooking time, and controls the rotation direction of the turntable bracket 91 and the submission of a serving plate. In the cooking device, the conveyer belt 10, the discharging mechanism, the cooking component 3 and other operation units are arranged compactly to minimize floor space. The feed toggle device 8 in the discharging mechanism is designed to only ensure that it can pick the ingredient boxes 41 on the conveyer belt 10 and push the ingredient box 41 to the storage platforms 11. In addition, the feed grip device 2 in the discharging mechanism can pick an ingredient box 41 on the conveyer belt 10 and rotate to move the ingredient box 41 to over the cooking pot 31, thereby pouring the ingredient into the cooking pot 31. Further, the feed grip device 2 can rotate the ingredient box 41 to over the garbage bag hanging ring 56 and enable the ingredient box 41 to fall into a garbage bag.

In this automatic cooking device, the lifting device 1 makes use of the height space. As long as a feed toggle device 8 at an appropriate height is provided, the conveyer belt 10 can be set at different heights as required, thereby adapting to the environmental space; its rear side can be against a wall, so that the conveyer belt 10 is close to the wall to reduce food contamination and accidents and avoid affecting the application and maintenance in daily operation. In the mode of mass production, when multiple cooking devices work simultaneously, ingredients can be transported faster; during cooking, the heat and fume from the cooking pot 31 disperse and splash to all directions. The design of multiple layers and back and forth movement can avoid mutual contamination among ingredients; the cooperation of the lifting device 1 and the feed grip device 2 (vertical and rotary conveyance) shortens ingredient transport distance and time, enables the addition of ingredients into the pot in a short time, and facilitates the handling of complex dishes; the feed grip device 2 adopts a double-shaft design, and the cooperation of the two shafts in rotation direction during discharging can more effectively stabilize the ingredient box 41.

1. A discharging mechanism for automatic cooking device, arranged on a cooking table, wherein the discharging mechanism comprises
a lifting device arranged on the side of the cooking table in a liftable manner and comprising a plurality of storage platforms of different heights overlapping in the vertical direction; and,
a feed grip device located on the side of the storage platforms and rotatably arranged on the top of the cooking table.

2. The discharging mechanism for automatic cooking device according to claim 1, wherein the lifting device comprises an upright bracket, which is arranged on the side of the cooking table in a liftable manner and on which the storage platforms are arranged horizontally.

3. The discharging mechanism for automatic cooking device according to claim 2, wherein each of the storage platforms comprises a U-shaped outer edge fixedly arranged on the upright bracket, a first base being arranged on the outer edge and in the middle of a U-shaped opening of the outer edge, and a second base matched with the structure of the opening of the outer edge being arranged at the opening of the U-shaped outer edge.

4. The discharging mechanism for automatic cooking device according to claim 3, wherein the outer edge is higher than the first base and the second base, and the first base, the second base and the outer edge forming a storage space open on the top to accommodate an ingredient box.

5. The discharging mechanism for automatic cooking device according to claim 3, wherein one or more base sensors are arranged on the top surface of the first base.

6. The discharging mechanism for automatic cooking device according to claim 2, wherein the upright bracket comprises a vertical plate and a connecting plate, the storage platforms being arranged on the vertical plate, the connecting plate being in an L shape, and the bottom end of the L-shaped connecting plate being provided with a moving part, which is arranged on the side of the cooking table in a liftable manner.

7. The discharging mechanism for automatic cooking device according to claim 6, wherein a vertical chute is arranged on the side of the cooking table where the lifting device is arranged, a sliding component being arranged inside the cooking table and along the chute and comprising a lead screw arranged at the chute, a slider slidably arranged on the lead screw, and an electric actuator arranged on the side of the lead screw and electrically connected to the slider, and the moving part and the slider passing through the chute and being fixedly connected.

8. The discharging mechanism for automatic cooking device according to claim 1, wherein the feed grip device comprises a first shaft driver arranged inside the cooking table, the top of the first shaft driver being rotatably connected to a first grip shaft, the top of the first grip shaft being connected to a rotary chamber, the rotary chamber being located on the top of the cooking table, and an open-type horizontal bar being arranged in the horizontal direction of the rotary chamber.

9. The discharging mechanism for automatic cooking device according to claim 8, wherein the open-type horizontal bar comprises a handle connected to the rotary chamber, the end of the handle away from the rotary chamber being provided with an arc claw, and the inner side of the arc claw being provided with an arc groove.

10. The discharging mechanism for automatic cooking device according to claim 9, wherein a second push rod shaft is arranged in the rotary chamber and comprises a telescopic driver arranged inside the rotary chamber, the side of the telescopic driver adjacent to the open-type horizontal bar being provided with a telescopic rod that is stretchable horizontally, the telescopic rod being extended outside the rotary chamber, the end of the telescopic rod away from the telescopic driver being provided with an arc pawl, the periphery of the telescopic rod being provided with a movable rod fixedly connected to the telescopic driver, and the handle of the open-type horizontal bar being arranged on the movable rod located outside the rotary chamber.

11. The discharging mechanism for automatic cooking device according to claim 10, wherein a second shaft driver is arranged inside the rotary chamber and rotatably connected to the second push rod shaft.

12. An automatic cooking device, wherein the automatic cooking device comprises the discharging mechanism according to claim 1.

13. The automatic cooking device according to claim 12, wherein the automatic cooking device further comprises a cooking component arranged on the cooking table on the side of the feed grip device at a height matched with the height of the feed grip device.

14. The automatic cooking device according to claim 13, wherein the cooking component comprises a cooking pot and a roll-over stand, the cooking pot being arranged on the roll-over stand in a rotatable manner, the roll-over stand being rotatably arranged on the cooking table, the rotary shaft of the roll-over stand being a horizontal shaft, and the rotary shaft for rotation of the cooking pot being a center shaft perpendicular to the bottom surface of the cooking pot.

15. The automatic cooking device according to claim 14, wherein a turntable device that can rotate horizontally is arranged on the cooking table at the bottom of the cooking pot, and comprises a turntable driver arranged inside the cooking table the top of the turntable driver being provided with a turntable shaft in a rotatable manner, the top of the turntable shaft being arranged outside the cooking table, a turntable bracket being horizontally connected to the turntable shaft outside the cooking table, the end of the turntable bracket away from the turntable shaft being provided with a clamp, a serving plate being clamped on the clamp, and when the turntable bracket rotates to the bottom of the cooking pot, the serving plate being under the cooking pot.

16. The automatic cooking device according to claim 15, wherein a blowdown device is arranged on the cooking table and located under the cooking pot.

17. The automatic cooking device according to claim 16, wherein an openable loading box is arranged at the bottom of the blowdown device, one or more liquid storage devices being arranged inside the loading box, and a weighing scale being arranged at the bottom of the liquid storage devices.

18. The automatic cooking device according to claim 17, wherein a stirring device and a charging device are arranged on the top of the cooking pot, and the charging device being connected to the liquid storage devices via pipes.

19. The automatic cooking device according to claim 18, wherein a mounting rack is arranged on the cooking table on the side of the cooking pot away from the feed grip device, a mounting box located on the top of the cooking pot being arranged on the mounting rack, the charging device being arranged in the mounting box and comprising one or more liquid pumps, the bottom surface of the mounting box being provided with nozzles, and the liquid storage devices and the liquid pumps all being connected to the nozzles via pipes.

20. The automatic cooking device according to claim 19, wherein a stirring device is arranged on the side of the nozzles on the bottom surface of the mounting box, and suction tubes connected to the liquid pumps being arranged inside the stirring device.

21. The automatic cooking device according to claim 12, wherein a feed toggle device is arranged on the cooking table behind the feed grip device and comprises a toggle lever driver inside the cooking table, the top of the toggle lever driver being rotatably connected to a toggle lever rotation shaft, the top of the toggle lever rotation shaft being arranged outside the cooking table, and a toggle lever being horizontally arranged on the toggle lever rotation shaft outside the cooking table and being able to rotate to the side of the storage platform.

22. The automatic cooking device according to claim 21, wherein a conveyer belt connected to a storage mechanism is arranged behind the cooking table and paved till the side of the storage platforms, the height of the conveyer belt on the side of the storage platforms being matched with the height of the toggle lever, ingredient boxes being transported on the conveyer belt, and a first box sensor being arranged on the cooking table on the side of the feed toggle device.

23. The automatic cooking device according to claim 12, wherein a second box sensor is arranged on the cooking table on the side of the feed grip device.

24. The automatic cooking device according to claim 12, wherein a garbage bag hanging ring is arranged on the cooking table on the side of the lifting device, and is on the front side of the lifting device.

25. The automatic cooking device according to claim 12, wherein a monitor that meets the ergonomic requirements is arranged on the front side of the cooking table.

26. An automatic cooking method based on the automatic cooking device according to claim 12, wherein the method comprises:
S1: after receiving a dish cooking instruction, the control system controls the conveyance of ingredient boxes filled with corresponding ingredients to the storage platforms at different heights;
S2: the control system controls the feed grip device to pour different ingredients into the cooking pot in the order required by the dish.

27. The automatic cooking method according to claim 26, wherein the method further comprises:
S3: the control system controls the charging device to add corresponding cooking oil and seasonings to the cooking pot according to the amount and sequence, and controls the rotation direction and speed, and cooking time of the cooking pot for cooking;
S4: after the cooking is completed, the control system controls the roll-over stand to rotate along the horizontal shaft to pour the finished product in the cooking pot into a serving plate at the bottom of the cooking pot, and controls the turntable device to rotate to hand over the serving plate.

28. The automatic cooking method according to claim 26, wherein S1 specifically comprises:
S1.1: after receiving a dish cooking instruction, the control system outputs a control command to the storage mechanism, and ingredient boxes filled with the required ingredients are sent onto the conveyer belt and conveyed along the conveyer belt to the side of the storage platforms of the lifting device;
S1.2: when the first box sensor on the cooking table detects that an ingredient box on the conveyer belt arrives at the side of the storage platforms, the corresponding storage platform is controlled to ascend or descend to a height matched with the conveyer belt, and then the toggle lever of the feed toggle device is controlled to rotate towards the storage platform and to toggle the ingredient box on the conveyer belt along the U-shaped opening of the outer edge of the storage platform into the storage space of the storage platform and after that, the toggle lever returns to the original position;
S1.3: S1.1-S1.2 are repeated to convey ingredient boxes filled with different ingredients to specific storage platforms at different heights.

29. The automatic cooking method according to claim 26, wherein S2 specifically comprises:
S2.1: the storage platform at the height of the ingredient to be added is controlled to ascend or descend to a height matched with the arc claw of the feed grip device, and the first grip shaft is controlled to rotate, driving the arc claw of the open-type horizontal bar to rotate horizontally to the ingredient box on the storage platform until the inner groove on the inner side of the arc claw is coupled with the upper outer edge of the ingredient box;
S2.2: the movable rod is controlled to stretch towards the ingredient box, driving the arc pawl to move forward and against the outer wall of the ingredient box;
S2.3: after the ingredient box is fixed by the arc claw and the pawl, the lifting device is controlled to move downward, and after the bottom of the ingredient box leaves the storage space, the first grip shaft is controlled to rotate, driving the ingredient box fixed at the open-type horizontal bar and the arc claw to rotate horizontally to the top of the cooking pot;
S2.4: the movable rod is controlled to rotate, driving the ingredient box fixed at the arc claw to rotate till the opening of the ingredient box faces the cooking pot, and the first grip shaft is controlled to rotate clockwise and anticlockwise at a small amplitude, driving the ingredient box to shake slightly, thereby pouring the ingredient in the ingredient box into the cooking pot.

30. The automatic cooking method according to claim 29, wherein S2 further comprises:
S2.5: after the ingredient in the ingredient box is poured into the cooking pot, the second push rod shaft is controlled to rotate in the reverse direction, driving the ingredient box to rotate till the opening of the ingredient box faces away from the cooking pot;
S2.6: the first grip shaft is controlled to rotate, driving the ingredient box at the open-type horizontal bar and the arc claw to rotate horizontally in the direction from the cooking pot to the garbage bag hanging ring, and move the ingredient box to the top of the garbage bag hung on the garbage bag hanging ring;
S2.7: the movable rod is controlled to retract so that the pawl moves away from the outer wall of the ingredient box, and the first grip shaft is controlled to rotate clockwise and anticlockwise at a small amplitude so that the ingredient box is detached from the arc claw and falls into the garbage bag;
S2.8: S2.1-S2.7 are repeated until all the ingredients needed by the dish are added to the cooking pot.
